(19) United States
(12) Patent Application Publication
(10) Pub. No.: US 2026/0023921 A1
(43) Pub. Date: Jan. 22, 2026

(54) SYSTEMS AND METHODS OF SHELLTOC TO MANAGE AND AUTOMATE SHELL DOCUMENTS AND TOC

(71) Applicant: Yuehua Cao, Novato, CA (US)

(72) Inventor: Yuehua Cao, Novato, CA (US)

(21) Appl. No.: 18/778,919

(22) Filed: Jul. 20, 2024

(51) Int. Cl. G06F 40/169; G06F 40/177; G06F 40/186

(52) U.S. Cl. CPC G06F 40/169; G06F 40/177; G06F 40/186

(57) ABSTRACT

A system for creating tables of contents (TOC) from shells stored in libraries or via manual addition to a document is provided. The accesses a shell template library, extracts selected shells from the library, creates a shell document or statistical analysis plan (SAP) document in Microsoft Word by inserting the selected shells or via manual addition to a document, and creates a TOC in Microsoft Excel or in a SQL database based on the shell document created in Word. The system creates the table of contents by receiving information exported from the shell document. The exported information comprises at least two of shell type, number, title, subtitle, footnote, and comments. Custom fields of the application are eligible for exporting into the table of contents document. The table of contents is alternatively created in a database.

### CROSS REFERENCE TO RELATED APPLICATIONS

None

### FIELD OF THE DISCLOSURE

The present disclosure is in the field of managing shells for large quantities of data. More particularly, the present disclosure provides systems and methods of selecting plurality of shells to be represented in tables of contents (TOC) and in which shell contents can be efficiently managed and synchronized with TOCs.

### BACKGROUND

In the biotech and pharmaceutical industry, many tests are conducted on drugs and devices during various phases of testing and examination. Biostatisticians author shell documents, which can be standalone documents or part of Statistical Analysis Plan documents (SAP), with shells of tables, figures, and listings used to measure if the drug/device is safe and effective, and need to make variations to tests from time to time. Statistical programmers develop computer programs that, when run, will output tables, figures, and listings that bear the exact same shell number, title, subtitle, and footnotes and use the test data. It is inefficient and inaccurate for computer programs to read that information from Microsoft Word documents directly. Programmers typically transcribe that information from Word documents to Microsoft Excel or database tables, called TOC.

Collaboration between biostatisticians and programmers is important but can be difficult. Biostatisticians are typically associated with shell documents. By contrast, TOCs are typically owned by programmers.

Computer programs developed by statistical programmers use TOC information along with input data to create corresponding outputs. The outputs should match the shell number, title, subtitle, and footnotes exactly as defined in shell document by the biostatistician. However, discrepancies can sometimes occur between the shell document and TOC for various reasons. For instance, biostatisticians make updates to the shell document but forget to inform the programmers or programmer might fail to transcribe all changes in Shell document to TOC, or programmers makes changes to TOC without communicating with biostatisticians.

### BRIEF DESCRIPTION OF THE FIGURES

FIG. 1 is a diagram of a system of shellTOC to manage and automate shell documents and TOC according to an embodiment of the present disclosure.

FIG. 2 is an image of a graphical user interface provided by a system of shellTOC to manage and automate shell documents and TOC according to an embodiment of the present disclosure.

### DETAILED DESCRIPTION

Systems and methods described herein provide a utility referred to as ShellTOC, a Microsoft Word add-in, that is directed to managing and automating shell documents and tables of contents, hereinafter TOC. A user begins by creating a shell document or statistical analysis plan (SAP) document. The user inserts shells selected from a shell template library or may create shells manually.

The user then creates a TOC in Microsoft Excel or in a database by selecting an object, for example an icon. This action exports information from the shell document to Excel or the database. The exported information may include shell type, number, title, subtitle, footnotes, and comments. Other custom fields may be included as well.

Users can customize tables in the shell document. They can change the number of columns and/or number of rows and they can make their own column titles. The user is promoted to replace columns of multiple tables with a new set of columns in a single operation resulting in each table cell having data in the correct format. Users may annotate shells in side panels of Word document.

Users may also update default annotations associated with shell templates and they may add new annotations as needed. Users may print shell documents with corresponding annotations in the side of an associated shell.

Systems and methods also provide for synchronization of TOCs with shell documents. Two-way synchronization between shell documents in Microsoft Word and TOCs in Excel or database is possible. The system identifies what has changed since the most recent synchronization between the shell document in Microsoft Word and the corresponding TOC in Excel or in a database.

The system presents a summary of all the changes from either side. It allows users to view each change in highlighted format. They may resolve conflicts in the event there are changes from both the shell and the TOC on the same shell instance. Users may enter reasons for any changes they have made. An example of such a change could be a short paragraph of text or a document link. An audit function is available that records who made what changes when for what reason and highlights changes in content that resulted from each synchronization.

Systems and methods also provide a quick edit function that collects information from shells in a shell document, categorizes them and presents the material in tabular form. It makes possible alterations of selected shell instances in a shell document concurrently.

The quick edit function promotes rapidly altering multiple selected records at the same time in a shell document. The alteration requests are for specific text strings in Word and are not fields in a programming sense. The utility is not using fields to enable identification of what category a specific item of information is in.

The quick edit function enables users to make editions in a tabular form and perform mass operations on selected shells. The operations include at least set, append, prepend, and replace. The quick edit function also relieves users of editing shell number, title, subtitle, footnotes, and comments information individually in shell document.

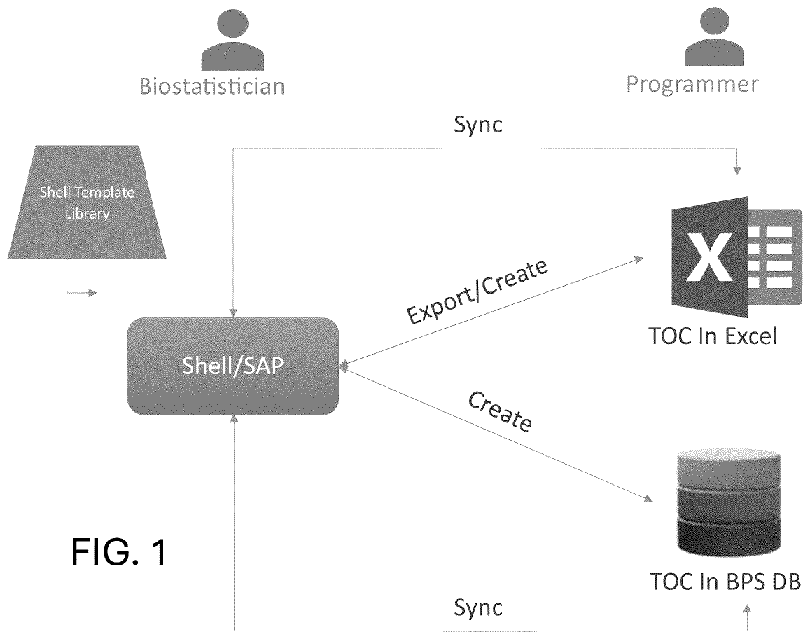

Turning to the figures, FIG. 1 is a diagram of a system of shellTOC to manage and automate shell documents and TOC according to an embodiment of the present disclosure. The flow of work is shown in FIG. 1 from shell template to shell and then on to either a Microsoft Excel TOC or a TOC in a database.

The biostatistician is shown near the shell document where they concentrate, and the programmers are shown near the TOC where their work typically is focused. Arrows for synchronization illustrate how synchronization may be done in both directions, i.e. two-way as noted above. A backup of versions of the shell document and TOC prior to each sync is recorded.

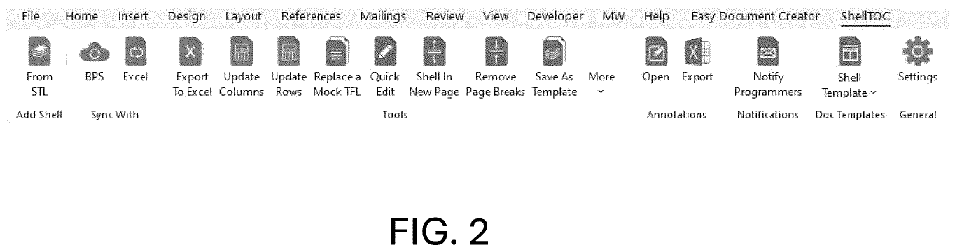

FIG. 2 is an image of a graphical user interface provided by a system of shellTOC to manage and automate shell documents and TOC according to an embodiment of the present disclosure. FIG. 2 shows a banner provided by shellTOC with many of the different options available to the user.

Systems and methods further enable users to annotate shells in a shell document in side panels of Word, where users can update the default annotation associated with a shell template or add new annotations as needed.

Users can replace columns in any number of selected tables with the new column configuration in one operation. Users may also add at least one highlighted row to selected tables and are allowed to delete highlighted rows from selected tables in one operation.

In an embodiment, a system for creating tables of contents (TOC) from shells stored in libraries or via manual addition to a document is provided. The system comprises a computer and application executing thereon that accesses a shell template library, extracts selected shells from the library, creates a shell document or statistical analysis plan (SAP) document in Microsoft Word by inserting the selected shells or via manual addition to a document, and creates a TOC in Microsoft Excel or in a SQL database based on the shell document created in Microsoft Word.

The system creates the table of contents by receiving information exported from the shell document. The exported information comprises at least two of shell type, number, title, subtitle, footnote, and comments.

The application is a Microsoft Word Add-In. Custom fields are eligible for exporting into the table of contents document.

The table of contents is alternatively created in a database. The system promotes a user to replace columns of multiple tables by a new set of columns in single operation with the right data format in each table cell.

The system promotes at least one of insertion of rows into and deletion of rows from multiple tables in single operation. Users annotate shells in side panels of Word, and wherein users update default annotations associated with shell templates or add new annotations as needed. The system allows users to print the shell document with the corresponding annotation in the side of an associated shell.

In another embodiment, a method of synchronizing discrepancies between table of contents documents (TOC) and shell documents used as sources for the table of contents documents is provided. The method comprises a computer receiving an instruction to reconcile discrepancies between a table of contents and a shell document used as a source for the table of contents, the discrepancies arising subsequent to a most recent synchronization of the table of contents with the shell document. The method also comprises the computer publishing a listing of changes to the table of contents and changes to the shell document since the synchronization. The method also comprises the computer requesting reasons for the changes from parties associated with the changes. The method also comprises the computer resolving conflicts arising from changes found to a particular instance in both the table of contents and the shell document.

The method also comprises the computer executing an Add-In application to Microsoft Word. The shell document is in Microsoft Word and the table of contents is in Microsoft Excel or a database application.

The shell document is created via insertion of selected shells from a shell template library or manually entered or pasted once the selected shells are correctly formatted. The table of contents is created by receiving an export from the shell document of shell number, title, subtitle, footnotes, and comments. An audit function that highlights content changes in each synchronization.

In yet another embodiment, a system for rapidly altering multiple selected records concurrently in a shell document created from shells stored in libraries or via manual addition to a document is provided. The system comprises a computer and application executing thereon that creates a shell document or statistical analysis plan (SAP) document in Microsoft Word by inserting shells selected from a shell template library or via manual addition to a document. The system also receives a request to select certain shells listed in a tabular form, receives alteration requests for specific information within the selected shells. The system also propagates the alterations to the specific shells while leaving other information in the shell and other shells unchanged.

The system invokes a quick edit function provided by the application to identify the selected shells and specific fields and propagate the alterations thereto. The quick edit function further enables users to make editions in a tabular form and perform mass operations on selected shells, the operations comprising at least one of set, append, prepend, and replace. The quick edit function relieves users of editing shell number, title, subtitle, footnotes, and comments information individually in shell document.

What is claimed is:

1. A system for creating tables of contents (TOC) from shells stored in libraries or via manual addition to a document, comprising:
a computer and application executing thereon that:
accesses a shell template library,
extracts selected shells from the library,
creates a shell document or statistical analysis plan (SAP) document in Microsoft Word by inserting the selected shells or via manual addition to a document, and
creates a TOC in Microsoft Excel or in a SQL database based on the shell document created in Microsoft Word.

2. The system of claim 1, wherein the system creates the table of contents by receiving information exported from the shell document.

3. The system of claim 2, wherein the exported information comprises at least two of shell type, number, title, subtitle, footnote, and comments.

4. The system of claim 1, wherein the application is a Microsoft Word Add-In.

5. The system of claim 1, wherein custom fields are eligible for exporting into the table of contents document.

6. The system of claim 1, wherein the table of contents is alternatively created in a database.

7. The system of claim 1, wherein the system promotes a user to replace columns of multiple tables by a new set of columns in single operation with the right data format in each table cell.

8. The system of claim 1, wherein the system promotes at least one of insertion of rows into and deletion of rows from multiple tables in single operation.

9. The system of claim 1, wherein users annotate shells in side panels of Word, and wherein users update default annotations associated with shell templates or add new annotations as needed.

10. The system of claim 1, wherein the system allows users to print the shell document with the corresponding annotation in the side of an associated shell.

11. A method of synchronizing discrepancies between table of contents documents (TOC) and shell documents used as sources for the table of contents documents, comprising:
a computer receiving an instruction to reconcile discrepancies between a table of contents and a shell document used as a source for the table of contents, the discrepancies arising subsequent to a most recent synchronization of the table of contents with the shell document;
the computer publishing a listing of changes to the table of contents and changes to the shell document since the synchronization;
the computer requesting reasons for the changes from parties associated with the changes; and
the computer resolving conflicts arising from changes found to a particular instance in both the table of contents and the shell document.

12. The method of claim 9, further comprising the computer executing an Add-In application to Microsoft Word.

13. The method of claim 11, wherein the shell document is in Microsoft Word and the table of contents is in Microsoft Excel or a database application.

14. The method of claim 11, wherein the shell document is created via insertion of selected shells from a shell template library or manually entered or pasted once the selected shells are correctly formatted.

15. The method of claim 11, wherein the table of contents is created by receiving an export from the shell document of shell number, title, subtitle, footnotes, and comments.

16. The method of claim 11, further comprising an audit function that highlights content changes in each synchronization.

17. A system for rapidly altering multiple selected records concurrently in a shell document created from shells stored in libraries or via manual addition to a document, comprising:
a computer and application executing thereon that:
creates a shell document or statistical analysis plan (SAP) document in Microsoft Word by inserting shells selected from a shell template library or via manual addition to a document,
receives a request to select certain shells listed in a tabular form,
receives alteration requests for specific information within the selected shells, and
propagates the alterations to the specific shells while leaving other information in the shell and other shells unchanged.

18. The system of claim 17, wherein the system invokes a quick edit function provided by the application to identify the selected shells and specific fields and propagate the alterations thereto.

19. The system of claim 18, wherein the quick edit function further enables users to make editions in a tabular form and perform mass operations on selected shells, the operations comprising at least one of set, append, prepend, and replace.

20. The system of claim 18, wherein the quick edit function relieves users of editing shell number, title, subtitle, footnotes, and comments information individually in shell document.
